(19) United States
(12) Patent Application Publication
(10) Pub. No.: US 2007/0179801 A1
(43) Pub. Date: Aug. 2, 2007

(54) Computer System and Process of Accounting for Sponsored Websites

(76) Inventor: Marvin Yakos, Eureka, MT (US)

Correspondence Address: JOEL I ROSENBLATT, 445 11TH AVENUE, INDIALANTIC, FL, 32903, US

(21) Appl. No.: 11/623,827

(22) Filed: Jan. 17, 2007

Related U.S. Application Data
(60) Provisional application No. 60/766,392, filed on Jan. 17, 2006.

(51) Int. Cl. G06Q 99/00

(52) U.S. Cl. 705/1

(57) ABSTRACT

The invention, as shown and disclosed for a preferred embodiment is a computer system and method for advertising and obtaining proceeds for educational institutions and other related organizations. The system and method comprises a two-sided system, with one side being a hierarchal management system for the marketing, financial, and operations of the system and on the other side comprising the respective educational institution website and the sponsoring organizations associated through the inventive system with the respective educational institutions.

### CROSS REFERENCE TO RELATED APPLICATIONS

Benefit is claimed under 35 U.S.C. 120 for provisional application 60/766,392, filed Jan. 18, 2006.

### FIELD OF INVENTION

This invention is in the field of constructing sponsored websites, through a hierarchal system for controlling and accounting for payments for and distributions attributable to the website, sponsors and website's management.

### BACKGROUND

To those skilled in the art, the theory and practice of sponsored website are well known. As in common use, a website may include sponsors which pay for space and a link to the sponsor's home or affiliate website. However, what is needed is a computer system and method for building a hierarchal network of management responsible for the accepted and well-known management functions of marketing and construction of the sponsored website, for accounting for payments and for accounting for distributions of those payments, in accordance with a payment and distribution plan.

### SUMMARY OF THE INVENTION

Accordingly, it is one object of this invention to provide for enrolling an organization, for example an educational institution at the primary or secondary level, in the system and to provide the educational institution with a website which may be customized for its use or to enroll the website for a respective educational institution,

Another object of the invention is connection of sponsor affiliates to an educational institution's website.

Another object of the invention is a system and method for real time management of a sponsor affiliate's content displayed on an educational institution's website, or through the institution's website.

Another object of this invention is to provide a system and method for a management hierarchy to perform the management tasks of marketing and financial control of income and distributions.

Another object of this invention is a channel for what is known to those skilled in the art as “back office operations.”

Another object of this invention is a system and method for a connecting educational institutions and sponsors in a national or other wide area, with one or more discount entitlements, which may be arranged through an identifying code or directly with an enrolled debit or credit card.

Another object of this invention is a system and method for producing or delivering financial reports for revenues and payments attributable to respective sponsors, institutions, marketing and management levels.

It is yet another object of this invention to provide a method and system for back office data processing of transactions between management levels, marketing levels, between a sponsor and a sponsored educational institution website.

Another object of this invention is local storage of screen content, linked to the enrolled educational institution website.

The invention, as shown and disclosed for a preferred embodiment is a computer system and method for advertising and obtaining proceeds for educational institutions and other related organizations. The system and method comprises a two-sided system, with one side being a hierarchal management system for the marketing, financial, and operations of the system and on the other side comprising the respective educational institution website and the sponsoring organizations associated through the inventive system with the respective educational institutions.

The disclosed inventive principles as shown for a preferred embodiment, comprises a computer system and method, programmed for operation of a range of complex functions in order to generate revenue for educational institutions and/or other organizations.

The disclosed system and method is two-sided. On one side is the management of the marketing, financial, and web related operations for enrolling and authorizing, educational institutional web sites and respective sponsors, and for providing administrative controls to the respective website participant. On the other side are the system enrollee operations, comprising the institutional website and the respective sponsors. An operational connection is provided between the respective sides for enrolling management personal at the hierarchal levels, for authorizing institution website and enrolling sponsors, and for providing administrative authority to respective website and sponsors.

On the management side is the hierarchal arranged management, as shown for a preferred embodiment, into areas and area related authority and responsibilities. At the level closest to the educational institution or organization website host is the account supervisor. The account supervisor may receive compensation according to performance under defined stored parameters. These parameters may comprise the quality or quantity of website the account supervisor brings into the system, the direct or indirect business activity connected to the respective website, or the amount of system generated revenue collected and disbursed.

Above the account supervisor are area managers and national directors, respectively linked in the respective hierarchy to each other For example, as shown in a preferred embodiment, a National Director with authority for a national region, is linked to its respective Area Managers who in turn are linked to their Account Supervisors, within the respective areas. However, as one skilled in the art would understand, the levels of, and responsibilities in the hierarch may be varied without departing from the disclosed inventive principles.

In accordance with the disclosed inventive principles, the financial operation includes accounting for all of the system transactions between the hierarchal levels on the management side, and on enrollee side, and for transactions between these two sides.

The system and method is disclosed as comprising a public side and private side. On the private side, are the databases with information about the management hierarchy, the authorities for each and the respective institutional website and sponsors attributed to each. For the private side on the enrollee side are sponsors' respective website authority, respective website accounts for example, educators and students permitted to enter the website and make transactions.

Between the management side and the enrollee side is the central system computer data processor used for processing and collecting system related data, and for accounting of transactions and payments due and accrued to enrollees, national managers, area managers, and account supervisors.

Above the two sides of the system, the management and enrollee sides respectively, is the central processing facility with system wide supervision authority. For purpose of explanation, the central processing authority is identified as SchoolHeart™. Under this system wide authority, the processes connected with the system wide and specific enrollee and sponsor related activity, are run as data processes, as would be well known to those skilled in the art. For the purpose of explanation, these processes are identified as back office operations, to describe the data operations, for example to construction of enrollee website, construction of sponsor links and advertisements in respective enrollee website, the provisioning of authority to website users and the authorities for approving system related credit or debit transactions and for receiving and processing payments.

The system and method may comprise authority to the educational institution and/or organization and/or merchants, businesses or individuals, and all Marketing Partners with back office access to change their personal information or to manage their particular functions on the website in real time and with minimal computer experience. The system and process provides a back office system and method for all of the transactions necessary or desirable for the system's initial development and continuing operations. For example, as shown for a preferred embodiment, the top level entity oversees and controls the SchoolHeart.com website, serving as a central data processing link between all lower level hierarchy on the management side, marketing partners, and on the educational institution, organization and merchants, businesses or individual's side.

SchoolHeart™ is a service mark of SchoolHeart, Inc.

The SchoolHeart™ method and system may provide an area wide or localized, discount pricing or payment system, which may utilize a discount card and which may be made available on the educational institutions and/or other organization's website for the various levels of sponsors comprising advertising merchants, businesses or individuals and members. Access to the discount program participants may be by the educational institution and/or other organization's website or by other means for their local area, as well as in a national database on all educational institutions and/or organization's website, so that members can receive discounts locally, regionally or nationwide from participating merchants, businesses or individuals when they travel.

What is shown, described and claimed is a method for operating a sponsored website for educational or non profit, organizations, to benefit from sponsorships from businesses or individuals, comprising the steps of, arranging at least a two-sided hierarchal data processing system under the authority of a central processing system, comprising a first management marketing system and a second sponsored organization system, and a central processing authority including a SchoolHeart web site; using said SchoolHeart central processing authority to operate data processing operations within said first management marketing system and said second sponsored organization system; using said first management marketing system to enroll at least one national director in the top level of a management or marketing hierarchy; creating a national director website for said national director; and using said national director web site to enroll a plurality of lower level entities in said national director management or marketing hierarchy; and using said SchoolHeart central processing authority for storing profiles for each said lower level entity comprising levels of authority and payment entitlements.

In the disclosed method, said step of organizing said plurality of lower level entities, includes the step of using said national director website to enroll area managers by receiving and storing area managers personal information, receiving an area manager fee, issuing a SchoolHeart identification number, password, or user name, for access to selected areas of said central processing data processor.

The method is shown including said step of allowing access to selected area of said SchoolHeart central processing data processor to view transaction information for respective area managers and the step of creating respective area manager web sites, and the step of using said respective area manager websites to enroll account supervisors within said management and marketing hierarchy; and the step of creating respective account supervisor web sites.

Further shown in the method is using said using a respective national director web site or a respective area manager web site, or a respective account supervisor web site, to enroll a sponsored organization; receiving and storing sponsored organization profile information and creating a web site visible for general viewing on the Internet, for said sponsored organization, using at least a part of said sponsored organization profile information; and using at least a part of said sponsored organization profile information, for creating a private web site for said sponsored organization, for entering and viewing or manipulation of data, by said sponsored organization personal or the respective national director, area manager, or account manager, for said sponsored organization.

As further shown the method step of creating said sponsored organization web site, includes the step of using said sponsored organization web site to enroll businesses or individual, sponsors for said sponsored organization; using said SchoolHeart central processing authority for selecting a level of advertising on said sponsored organization web site, for receiving and storing sponsored organization information for viewing on said sponsored organization web site, and for receiving payment from said sponsor; and the step of using said central processing authority to link a sponsored organization with a respective soliciting national director, area manager, or account manager, for said sponsored organization.

Other elements of the disclosed method are the step of using said SchoolHeart web site and said central processing authority to collect payments from said sponsors and for distributing from said sponsor payments, respective payments to respective sponsored organizations and to said soliciting national directors, area managers or said account managers, according to said payment entitlements; creating on a said respective sponsored organization web site, a web site for viewing or use by faculty, students, parents of students, or other member of said respective sponsored organization to post or exchange information, or for viewing or positing of information, by the general public; using said SchoolHeart web site for Internet access to the products or services of sponsors, on said SchoolHeart web site or on said sponsored organization web sites; using said SchoolHeart website for receiving and processing of purchases of sponsors products or services; and using said SchoolHeart central processing authority, to calculate and distribute payments to said management marketing hierarch or to said sponsored organizations, in accordance with said stored profile information.

The disclosed method uses a discount card program disclosed as including the step of, using said SchoolHeart web site to accept and store information from sponsors for participation in a discount card program; using said SchoolHeart web site to accept and store information from purchasers of said discount card; using said SchoolHeart central processing authority to identify purchased sponsors products or services with respective purchasers of discount cards for said purchases; calculating an discounted amount in response to said purchased sponsors products or services and for said respective purchasers of discount cards; and receiving payment made by said purchasers of discount cards and applying said discounted amount to said purchased sponsored products or services.

A system is disclosed for operating a sponsored website for educational or non profit, organizations, to benefit from sponsorships from businesses or individuals, comprising, first means for at least a two-sided hierarchal data processing system under the authority of a central processing system, comprising means for a first management marketing system and means for a second sponsored organization system, and means for a SchoolHeart central processing authority including a SchoolHeart web site.

The means for a SchoolHeart central processing authority is disclosed including means to operate data processing operations within said means for a first management marketing system and said means for a second sponsored organization system; the means to operate data processing operations within said means for a first management marketing system and said means for a second sponsored organization system, including means for enrolling at least one national director in the top level of a management or marketing hierarchy and means for storing a respective national director profile and for creating a national director website for said respective national director; and the means to operate data processing operations within said means for a first management marketing system and said means for a second sponsored organization system, including means for enrolling a plurality of lower level entities in said national director management or marketing hierarchy; and the means to operate data processing operations within said means for a first management marketing system and said means for a second sponsored organization system, including means for storing profiles for each said lower level entity including respective levels of authority and respective payment entitlements.

Further disclosed is the system wherein, said means to operate data processing operations within said means for a first management marketing system and said means for a second sponsored organization system, including means for using said national director website to enroll area managers by receiving and storing area managers personal information, receiving an area manager fee, issuing a SchoolHeart identification number, password, or user name, for access to selected areas of said central processing system.

Further disclosed is the system, wherein said means to operate data processing operations within said means for a first management marketing system and said means for a second sponsored organization system, includes means for creating respective area manager web sites, and means for access to selected area of said SchoolHeart central processing data processor to view transaction information for respective area managers.

Further disclosed is the system, wherein said means to operate data processing operations within said means for a first management marketing system and said means for a second sponsored organization system includes means for creating respective account supervisor web sites and means for using said respective area manager web sites to enroll account supervisors within said management and marketing hierarchy.

Further disclosed is the system, wherein said means to operate data processing operations within said means for a first management marketing system and said means for a second sponsored organization system includes, means for using said using a respective national director web site or a respective area manager web site, or a respective account supervisor web site, to enroll a sponsored organization; means for receiving and storing sponsored organization profile information and creating a web site visible for general viewing on the Internet, for said sponsored organization, using at least a part of said sponsored organization profile information; and means for using at least a part of said sponsored organization profile information, for creating a private web site for said sponsored organization, for entering and viewing or manipulation of data, by said sponsored organization personal or the respective national director, area manager, or account manager, for said sponsored organization.

Further disclosed is the system, wherein said means to operate data processing operations within said means for a first management marketing system and said means for a second sponsored organization system includes, means for using said sponsored organization web site to enroll businesses or individual, sponsors for said sponsored organization; means for using said SchoolHeart central processing authority for selecting a level of advertising on said sponsored organization web site, for receiving and storing sponsored organization information for viewing on said sponsored organization web site, and for receiving payment from said sponsor; and means for linking a sponsored organization with a respective enrolling national director, area manager, or account manager, for said sponsored organization.

Further disclosed is the system, wherein said means to operate data processing operations within said means for a first management marketing system and said means for a second sponsored organization system includes, means for using said SchoolHeart web site and said central processing authority to collect payments from said sponsors and for distributing from said sponsor payments, respective payments to respective sponsored organizations and to said enrolling national directors, area managers or said account managers, according to said payment entitlements.

Further disclosed is the system, wherein said means to operate data processing operations within said means for a first management marketing system and said means for a second sponsored organization system includes, means for creating on a said respective sponsored organization web site, a web site for viewing or use by faculty, students, parents of students, or other member of said respective sponsored organization to post or exchange information, or for viewing or positing of information, by the general public.

Further disclosed is the system, wherein said means to operate data processing operations within said means for a first management marketing system and said means for a second sponsored organization system includes, means for using said SchoolHeart web site for Internet access to the products or services of sponsors, on said SchoolHeart web site or on said sponsored organization web sites; means for using said SchoolHeart website for receiving and processing of purchases of sponsors products or services; and means for using said SchoolHeart central processing authority, to calculate and distribute payments to said management marketing hierarch or to said sponsored organizations, in accordance with said stored profile information.

Further disclosed is the system, wherein said means to operate data processing operations within said means for a first management marketing system and said means for a second sponsored organization system includes, means for using said SchoolHeart web site to accept and store information from sponsors for participation in a discount card program; using said SchoolHeart web site to accept and store information from purchasers of said discount card; means for using said SchoolHeart central processing authority to identify purchased sponsors products or services with respective purchasers of discount cards for said purchases; means for calculating an discounted amount in response to said purchased sponsors products or services and for said respective purchasers of discount cards; and means for receiving payment made by said purchasers of discount cards and applying said discounted amount to said purchased sponsored products or services.

### BRIEF DESCRIPTION OF THE DRAWING

FIG. 1, shows in a block diagram, according to each disclosed and labeled block and by the data flow as indicated by the arrows linking respective blocks, the data processing system according to the disclosed inventive principles.

### DESCRIPTION

“SchoolHeart,” is a service mark of SchoolHeart, Inc, and is used in the description of the invention to identify by its name, parts or elements of the operation and system. As would be recognized by those skilled in the art, the service mark “SchoolHeart,” by itself, does not refer to any utilitarian parts, systems or methods.

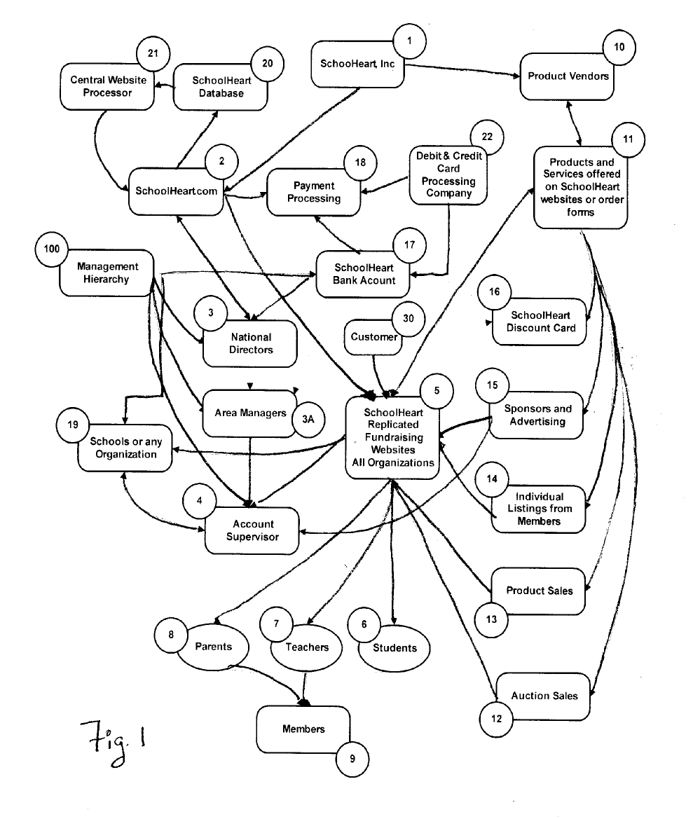

A data process for the inventive system and method is as shown in FIG. 1 with back office data process shown by the data links with the direction of data flow shown by the respective arrows. As shown in FIG. 1, at the hierarchal top of the system is the SchoolHeart.com central processing authority data processing system and web site 2, under the authority of the central organization SchoolHeart, Inc., shown generally by numeral 1. To start with the registration of a National Director, the system can collect the registration information gathered securely in the SchoolHeart database 20 via the internet and store it for later retrieval and use by the central website processor 21. After the National Director (“ND”), data is placed in data base 20, a SchoolHeart National Director Identification number is issued and simultaneously emailed to the newly enlisted national director, who is issued a password and username via that email for access to the security controlled back office of the SchoolHeart central processing authority data processing system 2.

On acceptance, the SchoolHeart central processing authority data processing system 2, creates a personalized website for the ND to authorize the ND to enroll and authorize Area Manager Registrations, to track sales commissions, to access and change personal information, and to run reports and to access and manage all management side related business activity. The personalized National Director website 3 is created by retrieving the information the National Director entered at the time of registration. From this National Director website all marketing partner information, educational institution and other organization information and all sales activity is now linked to the National Director through the SchoolHeart Database 20. All business and registrations that occur on the National Director website 3, or within that management hierarchy are now tracked by the SchoolHeart system 2, seamlessly and in real time and viewable by the National Director according to the ND's level of participation.

On the management side of the hierarchy, the organization of the system and method as disclosed for a preferred embodiment may start with enrollment of one or more entities identified as National Directors, and located at the management's hierarchy top marketing partner level. Enrollment of National Directors may be through the SchoolHeart website, as would be known to those skilled in the art. Back office processing and enrollment of National Directors may include credit or debit card processing, electronic banking, payment transactions and secured or unsecured transmittal and storage of respective profile information.

Individual website are provided for respective National Directors 3, for their respective use in enrolling Area Managers 3A, Account Supervisors 4, or other operative entities or marketing partners as may be accommodated in a preferred embodiment. Each of the lower entities in the management hierarchy may access and be enrolled in the website for the respective next higher level. In this way, the management hierarchy may be deepened and expanded by Account Supervisors, Area Managers or other marketing levels, with direct responsibility for enrolling and managing educational institutions and/or other organizations.

As for the National Director, within their back office transactions are profiles for each of the management hierarchy lower levels, to view all lower level sales, enrollments, data and activity, including levels of authority and entitlement of payments from the system revenues.

In explanation of the SchoolHeart process, a designated person goes to the ND personalized SchoolHeart website 3, and registers as an Area Manager 3A. The individual supplies personal information and submits the Area Manager fee online with a credit card or checking account information. The person's information is submitted securely online through the website and the information is collected in the SchoolHeart Database 20.

The Area Manager 3A or other lower level of marketing partner payment is submitted to the SchoolHeart central processing authority data processing system website 2, and then on to SchoolHeart's payment processors 18, for approval or denial by the debit or credit card processor 22. When the transaction is approved, the funds are deposited into the SchoolHeart Bank account 17, from the credit card processing company 22.

When the newly enrolled area manager enrollment process is completed, and the relevant information is in a secure database the area manager is issued a SchoolHeart Area Manager 3A Identification number. This information is displayed to him automatically through the internet to the area manager's processor 3A and displayed on the computer screen, as well as automatically sent via email in real time. The National Director 3 is also immediately notified within that National Director's back office as well as via email in real time. The new Area Manager 3A is issued a password and username to have access to their secure back office portion of the SchoolHeart system. All information is stored in the SchoolHeart Database.

Once accepted, the Area Manager 3A can now enroll Account Supervisors 4, on their respective Area Manager website 3A. The Account Supervisor personal information is collected and viewable during the registration on the Area Manager personal website, as well as by SchoolHeart administration and by the National Director in real time. If declined the individual is sent back an email notifying them of the refusal, and the Area Manager also receives such notice via email. If the Account Supervisor 4, is accepted, the National Director 3 and Area Manager 3A are notified within their respective back offices and via email in real time. The Area Manager assists SchoolHeart by selecting, managing and enrolling Account Supervisors within each area to help enroll and manage educational institutions and/or organizations and sponsors. There is no limit to the number of Account Supervisors per area. Their ultimate number is based on the geographic area, as well as the efforts and success of other Account Supervisors in the Area.

In accordance with disclosed inventive principles, according to a preferred embodiment, individuals wishing to apply to become Account Supervisors 3A can go directly to the Area Manager Website 3, and register. The individual pays the Account Supervisor fee online with a credit card or checking account information.

The payment process is through the SchoolHeart central processing authority data processing system website and then is submitted automatically to the payment processors 18, for payment approval or denial. If approved, the Account Supervisor information is submitted to the SchoolHeart database 20, and also to the Area Manger 3A and National Director 3 back offices and automatically via email in real time. After the Account Supervisor 3A, submits the information to the database the Account Supervisor is issued a SchoolHeart Identification number. This information is displayed to the Account Supervisor automatically through the internet to their computer screen and via email in real time. The Account Supervisor is also issued a password and username to have access to their own secure back office of the SchoolHeart system. All information is stored in the SchoolHeart Database 20 and accessible to SchoolHeart administration and Marketing Partners on all levels as participation allows.

After the payment is accepted the central processor, shown in preferred embodiments as the website SchoolHeart.com, will construct a new website for the respective new Account Supervisor 3A, a personalized SchoolHeart website that is designed to enroll educational institutions and/or other organizations. The educational institution and/or other organizations, 19, can be registered into the program by an Account Supervisor 4, Area Manager 3A, National Director, 3, or other levels of marketing partners, through their respective web sites and directly through the SchoolHeart web site, 2, and its data process or directly onto the SchoolHeart website 2, when necessary. The educational institution and/or organization 19, with direct access to the respective an Area Manager 3A and Account Supervisor 4, for support, may also be connected to the respective national director 3, or to the SchoolHeart web site 2 and associated central processor, 21.

The Account Supervisor 3A and/or Area Manager 3, or other levels of marketing partners are connected by their website to any individual educational institutions and/or other organizations 19, making an inquiring or making an application to join the SchoolHeart network.

As described herein, an educational institution 19, and/or organization is an entity that desires to receive additional proceeds to offset expenses or to finance special events.

A merchant, business or individual, shown by Product Vendors/Advertiser 10, in the preferred embodiment, is an entity that may desire to help with such proceeds for educational institutions and/or other organizations and in the process gain advertisement and promotional exposure. If the advertiser 10, accepts the company proposal as delivered in association with the SchoolHeart website 2 or the web sites of the enrolling National Director 3, Area Manager 3A, Account Supervisor 4, or other level of enrolling marketing partner, then the advertiser 10, interacts with the educational institution and/or organization's website and can access the business system back office and submit information they want members to see.

By back office is meant the data processing capability 21, at the central web site 2, for communication with all of the parties in the SchoolHeart network as explained herein and for transferring transaction information, reckoning of accounts and amounts due and owing and for storing the results in the data base 20, at the central processor 21 for the central web site 2. The back office data transmission and processing facility is transparent to the parties accessing and using the educational institution 19, web site 5.

In a preferred embodiment, all of the information submitted to the SchoolHeart system is sent to the central process 21 central processing authority data processing system website 2, where the information is filtered and encoded to protect the confidential information of the participants.

Because the SchoolHeart computer operated system is designed to increase proceeds for educational institutions and/or other organizations, certain information for example, accounts, pass words for gaining access to change website or to view accounts, are protected, as would be known to those skilled in the art.

For example, depending on the level of authority, pass words may be used by advertisers 10, to customize their respective displays on the associated educational web sites 5, with a customized website with unique features for that purpose. The website is designed so merchant, business, or individual advertisers can advertise on the selected page of the educational institution's and/or other organization's website. Merchants, businesses or individuals are also featured on several other pages of the educational institution's and/or other organization's website and on certain promotional materials. There are categories at different prices for merchants, businesses or individuals. Merchants, businesses or individuals also receive their own display page within the SchoolHeart website they can change and customize as needed.

Educational institutions and/or other organizations 19, may find it necessary to raise additional proceeds to offset expenses that strain budgets. Educational institutions and/or other organizations are often asked to sell items, often inconveniencing teachers, parents and students or other organizational administrator or members. Such fund raisers require out of pocket monies, money advances, and only a portion of the monies collected are retained. Unsold inventory as well as destroyed inventory is another disadvantage. Any time children sell door to door, there is a significant risk. Someone must be in charge and this entails many man hours from volunteers. Often prizes or other incentives are offered to motivate people. Much of the burden can be placed on the parents, both in terms of time and money. Parents may refuse, become stressed, or burden others. Someone must spend a considerable amount of time distributing the proceeds. Much time and special trips are needed to accomplish all this, and worst of all, it must be done time and time again. With SchoolHeart, the program is free to educational institution and/or other organizations, simple and the proceeds are residual, coming month after month. All reports are electronic within the SchoolHeart business system and in real time and viewable by the educational institutions and/or other organizations.

Authorized Individuals for an educational institution 19, that wish to enroll an individual educational institution and/or other organization go to the personal Account Supervisor 4 or other marketing partner level website and enroll the educational institution and/or other organization through the Account Supervisor 4, or Area Manager 3A or National Director 2, 2eb site where the enrollee's information is transmitted to the central process web site 2.

The information collected via the enrolling Marketing Partner Website and sent over the Internet to the central processing authority data processing system and web site 2. The SchoolHeart database 20 is used by the central processor 21 to populate the educational institution and/or other organization's individual website 5. When the information has been entered and the individual clicks submit, the individual educational institution and/or other organizational website is automatically created. The information is stored in the SchoolHeart database 20, and is shown in the appropriate places on the educational institution and/or other organization's personal website and also viewable by management and all levels of the particular hierarchy of marketing partners.

The website 5 has customizable features that can be changed at will by the educational institution and/or other organization.

Once the educational institution and/or other organization is enrolled, the National Director, Area Manager, SchoolHeart administration, Account Supervisor or other levels of marketing partners are notified by back office data processing of their respective website as well as via email in real time.

The educational institution and/or other organizations 19 now has a personalized SchoolHeart website 5, created automatically that is visible on the Internet. The educational institution and/or other organization, as part of the back office processing is provided a private web site for private and secure data to be viewed, entered or manipulated by educational institution and/or other organizational personnel or the Account Supervisor and appropriate hierarchy. In this section the authorized individual can login to the educational institution and/or other organization's personalized website's back office with a username and password, and then can complete additional forms to add valuable information to the educational institution and/or other organization's personalized website. This information can then be viewed via the Internet by members or the general public.

The hierarchy of marketing partners, educational institutions or other organizational personnel now solicit merchants, businesses or individuals to advertise on the educational institution and/or other organization's personalized website for the purpose of fund raising.

In the disclosed inventive method of establishing a system for earnings to the educational institutions by advertising on a replicated educational institution and/or organization's website, a contact is made with a merchant, business or individual by the Area Manager, Account Supervisor, National Director or electronically by the SchoolHeart, or by other level of marketing partners to propose advertising, and the method and technology necessary to seamlessly integrate all the above processes in real time, to obtain at least one potential merchant, business or individual to put an advertisement placement on the replicated educational institution and/or organizational website, all of which is seamlessly integrated into the money collection, payment, and commission business system.

The educational institution 19, and/or other organization and the Account Supervisor and/or Area Manger or other levels of marketing partners may assist each other in enrolling merchants, businesses or individuals to advertise on the individual SchoolHeart replicated website 5. Merchants, businesses or individuals enroll on the individual website. They each may choose a level of participation and complete the online enrollment form and submit payment through the management hierarchy 100, for processing by the central processing authority data processing system and web site 2, through the payment processing module 18. Payment received from the debit or credit card paying company is deposited in the SchoolHeart bank account 17.

The central processing authority data processing system 2, may be programmed as would be apparent to those skilled in the art to automatically charge each month for the web sites used by the educational institutions and for the sponsors' advertising space on the educational institution's and/or other organization's website.

Merchants, businesses and individuals may be allowed to enter the respective educational institutions and/or other organization's individual SchoolHeart website and select the level of advertising desired. The level of advertising is selected and the merchant, business or individual submits personal information and payment information to the central processing authority data processing website 2. The payment information is sent via the Internet to the payment processor for approval or denial. If approved, the transaction continues and the money is then sent electronically to the SchoolHeart bank account 17. Pertinent information can also be viewed on the National Director, Area Manager, Account Supervisor, and SchoolHeart Administration's back offices and is all sent to National Director, Area Manager, and Account Supervisor via email in real time.

After the payment is approved the merchant, business or individual advertiser completes the registration form for their particular level of advertising they have purchased. The merchant, business or individual advertiser is then directed to an area within their personalized back office. In this section they can provide and submit valuable information concerning their business that will be viewed by the general public on the internet via the educational institution and/or other organization's personalized website.

The merchant, business or individual's exposure and the size of their ad 11, as presented on the educational institution and/or other organization's personalized website is determined by the level of advertising they purchased. This section allows the advertiser to upload pictures, graphics, text, video, audio, drawings and other media formats to form or create their own display page on the educational institution and/or other organization's personalized website for members or the general public to view via the internet. This information is uploaded directly to the SchoolHeart database and displayed on the individual institution and/or other organization's personalized website in the appropriate place throughout the website based on the level of advertising selected.

The merchant, business or individual advertiser selects and submits payment for the advertisement on the educational institution and/or other organization's website. Payment is sent to payment processor for approval or denial. After the payment is accepted, the merchant, business or individual advertiser is sent an email with a username and password to access the private back office area for advertisers. National Director, Area Managers, Account Supervisors, or other levels of Marketing Partners, and SchoolHeart administration can view this information in their respective back offices and via email in real time.

In the merchant, business or individual advertiser's back office, the advertiser can access several sections including the advertising section 11. In this section the advertiser has access to the display page. This page can be changed in real time including text, graphics, video, pictures, sound and other acceptable media types. This page will appear on the educational institution and/or other organization's personalized website 5, and viewable by members or the public. The content for each individual display page is stored in the SchoolHeart's Database; the information is retrieved and displayed each time someone clicks on an educational institution and/or other organization's website or the link to the advertisers display page.

Each month under the control of the central processing web site, the payment for the advertising is automatically collected through the SchoolHeart payment system 18, for all advertisers. For each advertiser the fee is automatically charged to the payment method selected at the time the first advertising purchase was made. The recurring payment is submitted from the SchoolHeart system via the internet to the payment processor for approval or denial. If approved the advertisement remains in place. If the payment is denied the advertiser is contacted via email for another source of payment. If the payment is not collected within three days the advertisement is removed. The Regional Director, Area Manager, Account Supervisor, and other Marketing Partners, the educational institution and SchoolHeart administration are notified of the non-payment in their back offices and via email in real time.

Under the control of the central processing authority data processing system 2, for example, at the end of each month, all commissions are calculated for the Marketing Partners (National Director, Area Manager and Account Supervisor) and for each individual educational institution and/or organization. The funds are then sent by check or by electronic transfer for the amount each entity is owed for the previous month's commissions and/or proceeds.

All individual commissions and payments can be viewed by marketing partners and educational institutions and/or other organizations according to their level of participation in real time. Following the month payment is approved and received by SchoolHeart; all revenues are divided between the Marketing Partners and the individual educational institutions and/or other organizations.

After the calculations are complete the funds are transferred through payment processing 18, to the Marketing Partners and educational institutions and/or other organizations via check, electronic deposit or payments directly onto a credit or debit card from the SchoolHeart bank account.

Additional products and services (in addition to advertising from merchants, businesses or individuals) can be offered from assorted vendors for purposes of garnering additional proceeds for each individual educational institution and/or organizational site. These items could be purchased from each site using a shopping cart system. Each product sale would be tracked for the individual educational institution and/or organization and commissions are generated for the educational institution and/or other organization, as well as for all Marketing Partners using the same system and guidelines as advertising revenue.

The merchant, business or individual advertiser also has a choice of participating in the SchoolHeart discount card program.

The National Sponsor Program accepts a national merchant, business or individual for a select position on the educational institution and/or other organization's personalized website for discounts, offers and/or prizes and giveaways for the enrolled educational institutions and/or other organizations members and participants.

Merchants, businesses or individuals also have the option to participate in the SchoolHeart Discount card Program 16. The Discount Card will be for sale on all individual SchoolHeart website. Merchants, businesses or individuals are listed in a database that is visible on all individual SchoolHeart sites for all members and the public to see. Members or the public who purchase the discount card can use the card for a discount at any merchant or business location that participates in the program no matter where they live or where they purchased the discount card.

If merchant, business or individual advertiser selected the discount card program, they also must provide their current program discount, or special offers, prizes, giveaways, or other benefits to the public, members or customers via the educational institution and/or other organization's personalized website on their advertiser's display page. This information is submitted and updated through the merchant, business or individual advertiser's back office.

If merchants, businesses or individuals choose the SchoolHeart discount card program, their discounts can be used by any cardholder nationally, and the merchant, business or individual locations as well as a variety specials can be viewed on any SchoolHeart website.

Individuals can register as members of the SchoolHeart program via the Internet. The individual goes to the individual educational institution and/or other organization they are choosing to support and click the “sign up now” button. The individual enters their name and personal information required. The information is entered into the SchoolHeart database via the Internet. After the information is accepted by the central processing authority data processing system and web site 2, the individual is sent a return email by the SchoolHeart System with an Identification number and password. Members now have access to a private back office for additional features, such games, information, prizes, giveaways, promotions, discounts, advertiser features, display pages, broadcast messages, coupons for members to print, or other specialized advertiser information.

Members check to see if their ID number is showing on the home page of their educational institution's website. These ID numbers are randomly pulled from the database and displayed on the front page of each individual educational institution and/or other organization's website and can result in the member winning prizes, giveaways or other promotions.

Teachers and educational institution faculty can also access the educational institution's back office where they can post information such as homework, special notices, or send private messages to other members or the general public. SchoolHeart provides the members of the site (students, parents, teachers, or general public) with incentives to view the site on a daily basis, such as prizes from the merchants, businesses or individuals as well as giveaways from the educational institution and/or organization itself. SchoolHeart also provides the members and visitors with tools, web-based programs, games, information and useful links to use and enjoy on a daily basis that keep members and/or people visiting the site often.

The SchoolHeart system also generates reports for educational institutions and/or other organizations, Area Managers, Account Supervisors, National Directors, other levels of Marketing Partners, the Company and the Merchants, Businesses, or Individuals for assorted information as well as collected proceeds and commissions according to each segment and level of participation. There are individual methods for reporting results to educational institutions and/or other organizations, separate reports for marketing partners, and separate reports for SchoolHeart management and advertisers.

The system and process provides a back office system shown in FIG. 1, by data links showing directions of data flow by the respective arrows. The back office system and method for all of the transactions necessarily or desirable, for the systems initial development and continuing operations. For example, as shown for a preferred embodiment, the top level entity oversees and controls the SchoolHeart.com website, serving as a central data processing link between all of the lower level of the hierarchy on the management side and on the educational institution and sponsor side.

On the management side of the hierarchy, the organization of the system and method as disclosed for a preferred embodiment, may start with enrollment of one or more entities identified as National Directors, and located at the management hierarchy top level. Enrollment of National Directors may be through the SchoolHeart website, as would be known to those skilled in the art. Back office processing and enrollment of National Managers may include credit or debit card, payment transactions and secured or unsecured, transmittal and storage of respective profile information.

Individual website are provided for the profile data for respective National Directors and their respective use in enrolling Area Managers or other operative entities as may be accommodated in a preferred embodiment. Each of the lower entities in the management hierarchy, may access and be enrolled in the website for the respective next higher level. In this way, the management hierarchy may be deepened and expanded, by Account Supervisors, or another level, with direct responsibility for the educational institutions.

As for the National Director, within the back office transactions are profiles for each of the management hierarchy lower levels, including levels of authority and entitlement of payments from the system revenues.

Within the system and focus of the invention, as disclosed for a preferred embodiment, is the customer 30 shown connected to a SchoolHeart replicated website, for example for a respective educational institute. A customer, 30, accessing the SchoolHeart website 30, has access to products and services presented on the website 30 and through the website 30, to the products and services offered by the SchoolHeart website 2 or to the web sites represented by block 11, for products or services offered on respective provider's websites.

In the operation of the invention, as disclosed for a preferred embodiment, the Sponsors and Advertising 15, or individual listings from members 13, may link respective products and services 11 respective replicated web sites for presentation to the customer 30 and for purchase through the SchoolHeart web site 2, central processor 21 and data base 20 and in conjunction with payment processing 18 and associate debit and credit processing 22, for payment into the SchoolHeart ban account 17, and for distribution of amounts payable to the individual members of the management hierarchy 100, and the educational or other institutions 19, sponsoring the respective web site 5. The amounts due and accrued to each recipient is calculated by the central website processor 21, in response to the transactional data collected for transactions over the or through the SchoolHeart system method and in accordance with an algorithm stored in the data base 20 for calculation of payments due to the management hierarchy 100, and the educational or other organization hosting the replicated websites 5.

In a preferred embodiment, a discount card may be used with a sale through the system, when a purchase is made or for accessing a respective website 5. The discount card directory will encompass local, regional and national vendors in a national data base and connect to all the features depicted above. Auction sales 12, may be arranged, as would be known to those skilled in the art, through a respective website and the School Heart central processing authority data processing system and web site 2, and its central processor 21.

As would be apparent to those skilled in the art, modifications may be made to the disclosed inventive principles, without changing the disclosed invention's operation, methods, function, or result.

1. A method for operating a sponsored website for educational or non profit, organizations, to benefit from sponsorships from businesses or individuals, comprising the steps of, arranging at least a two-sided hierarchal data processing system under the authority of a central processing system, comprising a first management marketing system and a second sponsored organization system, and a central processing authority and central processing authority web site; using said central processing authority to operate data processing operations within said first management marketing system and said second sponsored organization system;
using said first management marketing system to enroll at least one national director in the top level of a management or marketing hierarchy;
creating a national director website for said national director; and
using said national director web site to enroll a plurality of lower level entities in said national director management or marketing hierarchy; and
using said central processing authority for storing profiles for each said lower level entity comprising levels of authority and payment entitlements.

2. The method of claim 1, wherein, said step of organizing said plurality of lower level entities, includes the step of using said national director website to enroll area managers by receiving and storing area managers personal information, receiving an area manager fee, issuing an identification number, password, or user name, for access to selected areas of said central processing data processor.

3. The method of claim 2, above, including said step of allowing access to selected area of said central processing data processor to view transaction information for respective area managers and the step of creating respective area manager web sites.

4. The method of claim 3, including the step of using said respective area manager websites to enroll account supervisors within said management and marketing hierarchy; and the step of creating respective account supervisor web sites.

5. The method of claim 4, including the step of,
using said using a respective national director web site or a respective area manager web site, or a respective account supervisor web site, to enroll a sponsored organization;
receiving and storing sponsored organization profile information and creating a web site visible for general viewing on the Internet, for said sponsored organization, using at least a part of said sponsored organization profile information; and
using at least a part of said sponsored organization profile information, for creating a private web site for said sponsored organization, for entering and viewing or manipulation of data, by said sponsored organization personal or the respective national director, area manager, or account manager, for said sponsored organization.

6. The system of claim 5, wherein said step of creating said sponsored organization web site, includes the step of,
using said sponsored organization web site or said central processing authority web site, to enroll businesses or individual, sponsors for said sponsored organization;
using said central processing authority or said sponsored organization web site for selecting a level of advertising on said sponsored organization web site, for receiving and storing sponsored organization information for viewing on said sponsored organization web site, and for receiving payment from said sponsor; and
the step of using said central processing authority to link a sponsored organization with a respective soliciting national director, area manager, or account manager, for said sponsored organization.

7. The method of claim 6, including the step of using said central processing authority to collect payments from said sponsors and for distributing from said sponsor payments, respective payments to respective sponsored organizations and to said soliciting national directors, area managers or said account managers, according to said payment entitlements.

8. The method of claim 7, including the step of,
creating on a said respective sponsored organization web site, a web site for viewing or use by faculty, students, parents of students, or other member of said respective sponsored organization to post or exchange information, or for viewing or positing of information, by the general public.

9. The method of claim 7, including the step of,
using said central processing authority web site for Internet access to the products or services of sponsors, on said central processing authority web site or on said sponsored organization web sites;
using said central processing authority website for receiving and processing of purchases of sponsors products or services;
using said central processing authority central processing authority, to calculate and distribute payments to said management marketing hierarch or to said sponsored organizations, in accordance with said stored profile information.

10. The method of claim 9, including the step of,
using said central processing authority web site to accept and store information from sponsors for participation in a discount card program;
using said central processing authority web site to accept and store information from purchasers of said discount card;
using said central processing authority to identify purchased sponsors products or services with respective purchasers of discount cards for said purchases; and
calculating an discounted amount in response to said purchased sponsors products or services and for said respective purchasers of discount cards;
receiving payment made by said purchasers of discount cards and applying said discounted amount to said purchased sponsored products or services.

11. A system for operating a sponsored website for educational or non profit, organizations, to benefit from sponsorships from businesses or individuals, comprising,
first means for at least a two-sided hierarchal data processing system under the authority of a central processing system, comprising means for a first management marketing system and means for a second sponsored organization system, and means for a central processing authority and a central processing authority web site;
said means for a SchoolHeart central processing authority including means to operate data processing operations within said means for a first management marketing system and said means for a second sponsored organization system;
said means to operate data processing operations within said means for a first management marketing system and said means for a second sponsored organization system, including means for enrolling at least one national director in the top level of a management or marketing hierarchy and means for storing a respective national director profile and for creating a national director website for said respective national director; and
said means to operate data processing operations within said means for a first management marketing system and said means for a second sponsored organization system, including means for enrolling a plurality of lower level entities in said national director management or marketing hierarchy; and
said means to operate data processing operations within said means for a first management marketing system and said means for a second sponsored organization system, including means for storing profiles for each said lower level entity including respective levels of authority and respective payment entitlements.

12. The system of claim 11, wherein,
said means to operate data processing operations within said means for a first management marketing system and said means for a second sponsored organization system, including means for using said national director website to enroll area managers by receiving and storing area managers personal information, receiving an area manager fee, issuing an identification number, password, or user name, for access to selected areas of said central processing system.

13. The system of claim 12, above, wherein said means to operate data processing operations within said means for a first management marketing system and said means for a second sponsored organization system, includes means for creating respective area manager web sites, and means for access to selected area of said central processing data processor to view transaction information for respective area managers.

14. The system of claim 13, wherein said means to operate data processing operations within said means for a first management marketing system and said means for a second sponsored organization system includes means for creating respective account supervisor web sites and means for using said respective area manager web sites to enroll account supervisors within said management and marketing hierarchy.

15. The system of claim 14, wherein said means to operate data processing operations within said means for a first management marketing system and said means for a second sponsored organization system includes,
means for using said using a respective national director web site or a respective area manager web site, or a respective account supervisor web site, to enroll a sponsored organization;
means for receiving and storing sponsored organization profile information and creating a web site visible for general viewing on the Internet, for said sponsored organization, using at least a part of said sponsored organization profile information; and
means for using at least a part of said sponsored organization profile information, for creating a private web site for said sponsored organization, for entering and viewing or manipulation of data, by said sponsored organization personal or the respective national director, area manager, or account manager, for said sponsored organization.

16. The system of claim 15, wherein said means to operate data processing operations within said means for a first management marketing system and said means for a second sponsored organization system includes,
means for using said sponsored organization web site to enroll businesses or individual, sponsors for said sponsored organization;
means for using said central processing authority for selecting a level of advertising on said sponsored organization web site, for receiving and storing sponsored organization information for viewing on said sponsored organization web site, and for receiving payment from said sponsor; and
means for linking a sponsored organization with a respective enrolling national director, area manager, or account manager, for said sponsored organization.

17. The system of claim 16, wherein said means to operate data processing operations within said means for a first management marketing system and said means for a second sponsored organization system includes,
means for using said central processing authority to collect payments from said sponsors and for distributing from said sponsor payments, respective payments to respective sponsored organizations and to said enrolling national directors, area managers or said account managers, according to said payment entitlements.

18. The system of claim 17, wherein said means to operate data processing operations within said means for a first management marketing system and said means for a second sponsored organization system includes,
means for creating on a said respective sponsored organization web site, a web site for viewing or use by faculty, students, parents of students, or other member of said respective sponsored organization to post or exchange information, or for viewing or positing of information, by the general public.

19. The system of claim 17, wherein said means to operate data processing operations within said means for a first management marketing system and said means for a second sponsored organization system includes,
means for using said central processing authority web site for Internet access to the products or services of sponsors, on said central processing authority web site or on said sponsored organization web sites;
means for using said central processing authority website for receiving and processing of purchases of sponsors products or services; and
means for using said central processing authority, to calculate and distribute payments to said management marketing hierarch or to said sponsored organizations, in accordance with said stored profile information.

20. The system of claim 19, wherein said means to operate data processing operations within said means for a first management marketing system and said means for a second sponsored organization system includes,
means for using said central processing authority web site to accept and store information from sponsors for participation in a discount card program;
means for using central processing authority web site to accept and store information from purchasers of said discount card;
means for using said central processing authority to identify purchased sponsors products or services with respective purchasers of discount cards for said purchases;
means for calculating an discounted amount in response to said purchased sponsors products or services and for said respective purchasers of discount cards; and
means for receiving payment made by said purchasers of discount cards and applying said discounted amount to said purchased sponsored products or services.
